(19) United States
(12) Patent Application Publication
(10) Pub. No.: US 2008/0104166 A1
(43) Pub. Date: May 1, 2008

(54) MOBILE OPERATION SUPPORT CENTER

(76) Inventor: Carmen Elena Alvarez, Missouri City, TX (US)

Correspondence Address: SCHLUMBERGER INFORMATION SOLUTIONS, 5599 SAN FELIPE, SUITE 1700, HOUSTON, TX, 77056-2722, US

(21) Appl. No.: 11/618,524

(22) Filed: Dec. 29, 2006

Related U.S. Application Data
(60) Provisional application No. 60/863,804, filed on Oct. 31, 2006.

(51) Int. Cl. G06F 15/16

(52) U.S. Cl. 709/203

(57) ABSTRACT

Modular mobile operation support center for supporting oilfield operations is disclosed that overcomes the lack of mobility or quick-response capability of existing solutions and well as other problems. The modular mobile operation support center comprises one or more portable, self-contained modules or stations, each module or station capable of providing real-time surveillance of remote oilfield operations. The portable, self-contained modules or stations allow the mobile operation support center to be quickly and easily moved from one location to another in a substantially assembled state to support an oilfield operation. Appropriately-trained oilfield personnel, such as drilling engineers, geosteering coordinators, and the like, may then use the mobile operation support center to monitor well-site operations and other remote oilfield operations either at their own facility or at a client's facility.

### CROSS-REFERENCE TO RELATED APPLICATIONS

This application for patent claims priority to, and hereby incorporates by reference, U.S. Provisional Application Ser. No. 60/863,804, entitled “Mobile Operation Support Center,” filed Oct. 31, 2006, with the United States Patent and Trademark Office.

### BACKGROUND OF THE INVENTION

1. Field of the Invention

The present invention relates to methods and systems for providing an operation support center for oilfield-related projects. In particular, the invention provides methods, apparatuses and systems for more quickly and conveniently setting up an operation support center in support of such oilfield-related projects.

2. Background of the Invention

Existing solutions for providing operation support in oilfield-related projects entail setting up a predefined area called a “control” or “expert” area either on-site or at client offices. The control/expert area is intended for use by appropriately-trained support personnel to focus on specific high-profile or troublesome oilfield projects. In the control/expert area, the appropriately-trained support personnel can view various information about a particular high-profile or troublesome project in more detail without interrupting the project. These control/expert areas are typically equipped with computers powerful enough to run any oilfield-related monitoring software applications currently in use as well as most specialized software applications. When additional personnel is required or if a meeting must be conducted such that another room is needed, the support personnel can use the controls available in the control/expert area to support the additional personnel or the meeting in the other room.

In a typical arrangement, the control/expert area is equipped with four computers connected to as many as six different displays (e.g., three monitors, two overhead projectors, and a plasma display). At least three of these computers are equipped with quad-output video cards (i.e., video cards with four independent outputs) plus an on-board dual-output video card. These two video cards (quad-output and dual-output cards) provide the hardware configuration needed for each of the three computers to output data and information to all six displays. The result is at least 20 video outputs, including six outputs from three computers equipped with quad-output and dual-output video cards, plus a fourth computer that usually has a factory-installed dual-output display. A video matrix controller may be used by the support personnel to select any six out of the 20 possible displays to output information.

A problem with existing control/expert areas is their lack of mobility and quick-response capability. This is because each control/expert area must be set up from scratch at every location, typically requiring an inordinate amount of time due to various the equipment involved (e.g., several days to a week). For at least the same reasons, it usually takes a long time to tear down a fully assembled control/expert areas. As a result, existing control/expert areas cannot be easily moved from one location to another, particularly on short notice.

Thus, despite recent advances, there remains a need for more effective systems and methods of providing operation support for oilfield-related projects. In particular, there is a need for such methods and systems to provide an operation support center than can, among other things, be quickly and easily moved from one location to another, particularly on short notice.

### SUMMARY OF THE INVENTION

The present invention is directed to a modular mobile operation support center that overcomes the lack of mobility and quick-response capability of existing solutions and well as other problems. The modular mobile operation support center of the invention comprises one or more portable, self-contained stations or modules, each station or module capable of providing real-time surveillance of oilfield operations. Appropriately-trained oilfield personnel, such as drilling engineers, geosteering coordinators, and the like, may then use the mobile operation support center to monitor well-site operations and other oilfield operations either at their own facility or at a client's facility. Such an arrangement provides a number of advantages over existing solutions.

In general, in one aspect, the invention is directed to a mobile operation support center for supporting an oilfield operation. The mobile operation support center comprises one or more tables, each table preferably having a plurality of legs, each leg having a wheel attached thereto, and a computer mounted to each table, the computer being equipped with multiple independent video outputs. The mobile operation support center further comprises one or more monitor displays disposed on top of each table, each monitor display being connected to one of the video outputs of the computer. At least one video matrix switch is mounted to each table, the at least one video matrix switch being connected to the video outputs of the computer and operable to provide one or more of the video outputs of the computer to an external display device. The one or more tables and the computer mounted thereto may be moved from one room to another in a substantially assembled state for supporting the oilfield operation.

In general, in another aspect, the invention is directed to a method of providing support for an oilfield operation. The method comprises setting up a mobile operation support center in a first area at a remote facility and receiving operations data from the oilfield operation at the remote facility. The method further comprises monitoring the operations data in the first area using the mobile operation support center and moving the mobile operation support center in a substantially assembled state to a second area at the remote facility. The operations data may then be monitored in the second area using the mobile operation support center.

In general, in yet another aspect, the invention is directed to a mobile operation support center for supporting an oilfield operation. The mobile operation support center comprises means for deploying a computer, the computer being equipped with multiple independent video outputs, and means for displaying output video from the multiple independent video outputs of the computer. The mobile operation support center further comprises means for providing at least one video matrix switch mounted to each table, the at least one video matrix switch connected to the video outputs of the computer and operable to provide one or more of the video outputs of the computer to an external display device. The means for deploying the computer may then be moved from one room to another in a substantially assembled state for supporting the oilfield operation.

### BRIEF DESCRIPTION OF THE DRAWINGS

FIG. 1 illustrates an exemplary station or module of the mobile operation support center according to a preferred embodiment of the invention;

FIG. 2 illustrates exemplary tables that may be used for the mobile operation support center according to a preferred embodiment of the invention;

FIG. 3 illustrates a plurality of stations or modules of the mobile operation support center assembled together according to a preferred embodiment of the invention; and

FIG. 4 illustrates an exemplary method for supporting an oilfield operation using a mobile operation support center in accordance with a preferred embodiment of the invention.

### DETAILED DESCRIPTION OF THE DRAWINGS

In the following detailed description of a preferred embodiment and other embodiments of the invention, reference is made to the accompanying drawings. It is to be understood that those of skill in the art will readily see that other embodiments and changes may be made without departing from the scope of the invention.

As explained above, existing control/expert areas are predefined areas that cannot be easily relocated, particularly on short notice, due to their lengthy setup and tear down time. Embodiments of the invention provide an operation support center that can be quickly and easily moved from one location to another. The mobility allows the operation support center to be used, for example, to set up surveillance activities in virtually any location on-site or at client offices in support of oilfield-related projects. Such a mobile operation support center may subsequently be moved, for example, to a conference room to facilitate collaborative sessions and the like with minimal or no interruption of the monitoring activity. Both projection systems as well as large screen displays may be easily connected to the modular mobile operation support center. And the mobile operation support center of the invention may be scaled as needed to accommodate moderate jobs as well as more complicated and difficult projects.

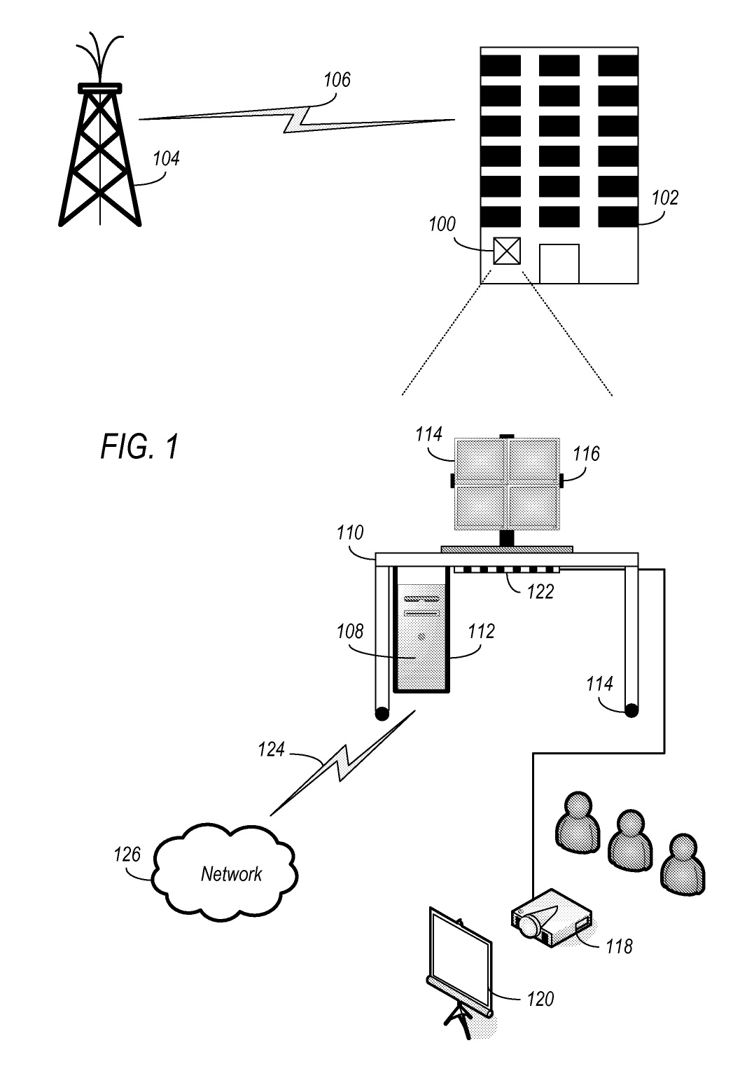

In preferred embodiments, the mobile operation support center is a modular mobile operation support center in that it comprises one or more discrete, self-contained modules or stations. FIG. 1 illustrates an exemplary modular mobile operation support center 100 according to a preferred embodiment of the invention. The modular mobile operation support center 100 is typically set up in a remote facility 102, such as an oilfield client's facility or an oilfield service provider's facility, in support of an oilfield operation 104. Various types of data and/or information from the oilfield operation, including video data, may then be transmitted via a wired and/or wireless connection 106 to the facility 102 and fed to the modular mobile operation support center 100 for surveillance purposes. Appropriately-trained oilfield personnel may then use the modular mobile operation support center 100 to monitor the data and/or information in real time as needed. Although only one module or station is shown, those having ordinary skill in the art will recognize that additional modules or stations may be added as needed according to the size of the oilfield operation being supported.

As can be seen in FIG. 1, each module or station of the modular mobile operation support center 100 may comprise one or more computers 108 mounted under a table 110 via a computer mounting mechanism 112 affixed (e.g., bolted, screwed, welded, etc.) to the table 110. The computer mounting mechanism 112 may be any suitable computer mounting mechanism known to those having ordinary skill in the art, such as a rack or bracket mount. Wheels 114, preferably of the lockable variety, are attached to the legs of the table 110 to allow the table 110 to be easily moved from one location to another. The computers 108, which may be desktop computers, laptop computers, servers, workstations, and the like, preferably have enough computing capacity to run any oilfield-related monitoring software applications known to those having ordinary skill in the art as well as most specialized software applications. Preferably, any software application needed is preloaded on the computer before deployment of the mobile operation support center.

Although not expressly shown, each computer 108 further has up to four video outputs or more that may be connected to a corresponding number of monitor displays 116. The monitor displays 116 may be any suitable type of monitor displays (e.g., LCD, CRT, etc.) and may be arrayed on top of the table 110, for example, in a 2×2 array (as shown) via a suitable monitor stand 118 in a shared screen real state mode. Any video output may also be shared with an external projector 120 and projection screen 122 by use of an appropriate video switch 124 (e.g., a 4×2 matrix switch) mounted, for example, underneath the wheeled table 110. Each computer 108 may also have a wired and/or wireless network card (not expressly shown) for establishing a wired and/or wireless connection 126 to a network 128. The computer 108, monitor displays 116, video switch 124, and other components thus mounted to and/or under the wheeled table 110 may have their power requirements integrated so that only one power source (e.g., a wall outlet) is needed.

The above arrangement allows each module or station of the modular mobile operation support center 100 to be quickly and easily moved from one location to another without having to tear down the entire setup. In addition, because each module or station of the modular mobile operation support center 100 is self-contained, it may be set up in virtually any room of the client's and/or service provider's facility instead of a predefined area. Thus, for example, any module or station of the modular mobile operation support center 100 may be quickly and easily moved to a conference room to facilitate collaborative sessions and the like with minimal or no interruption of the surveillance activity. Note that although the table 110 is shown as having multiple legs, it is well within the knowledge of those skilled in the art to use a single leg instead, such leg terminating in a plurality of support branches, each branch having a wheel attached thereto, similar to the single leg seen on a typical office chair.

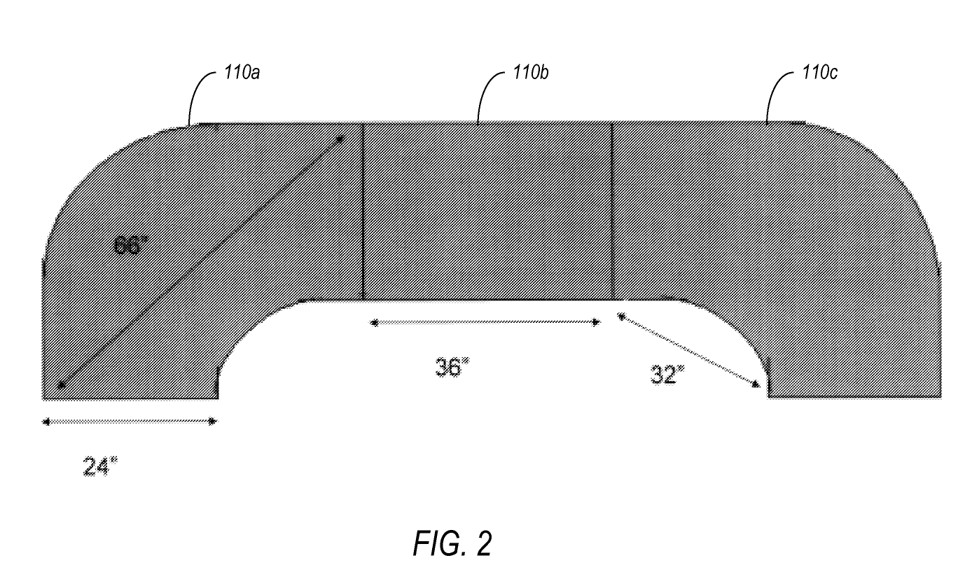

FIG. 2 illustrates exemplary tables 110 that may be used for the mobile operation support center 100. Preferably, the tables 110 are made up a lightweight material and are mounted on wheels (see FIG. 1) to allow rapid transportation and deployment in virtually any room at the client's or service provider's facility. In the embodiment shown, the mobile operation support center 100 includes two end tables 110a and 110c and at least one center table 110b. Each table 110a-c may be used as a stand-alone module, or several tables 110a-c may be combined to form a single, multi-module mobile operation support center 100.

Preferably, each table 110a-c is small enough to fit through a standard-sized doorway, but not so small as to make the tables 110a-c difficult for a person of average size to use. To this end, in one embodiment, the end tables 110a and 110c, which have a quarter-circle shape, may be approximately 24 inches wide and approximately 66 inches long as measured from the two corners farthest apart and 32 inches long as measured from the remaining two corners. The legs of the end tables 110a and 110c may be approximately 29 inches tall, and there may be up to five or more legs per end table 110a and 110c, each leg having wheels that may be locked in place for stability. The center table 110b, which may have a rectangle shape, may be approximately 24 inches wide and 36 inches long as measured from the two corners farthest apart, and there may be up to four or more legs per center table 110b, each leg measuring approximately 29 inches tall and having lockable wheels. In a preferred embodiment, two end tables 110a and 110c and one center table 110b may be assembled together in a kidney-shaped arrangement to facilitate simultaneous viewing of the various monitor displays. Removable screws, plates, and similar locking mechanisms may be used to hold the tables 110a-c together. Of course, as mentioned above, each table 110a-c may also be deployed by itself by virtue of each station or module of the mobile operations support center 100 being complete and self-contained.

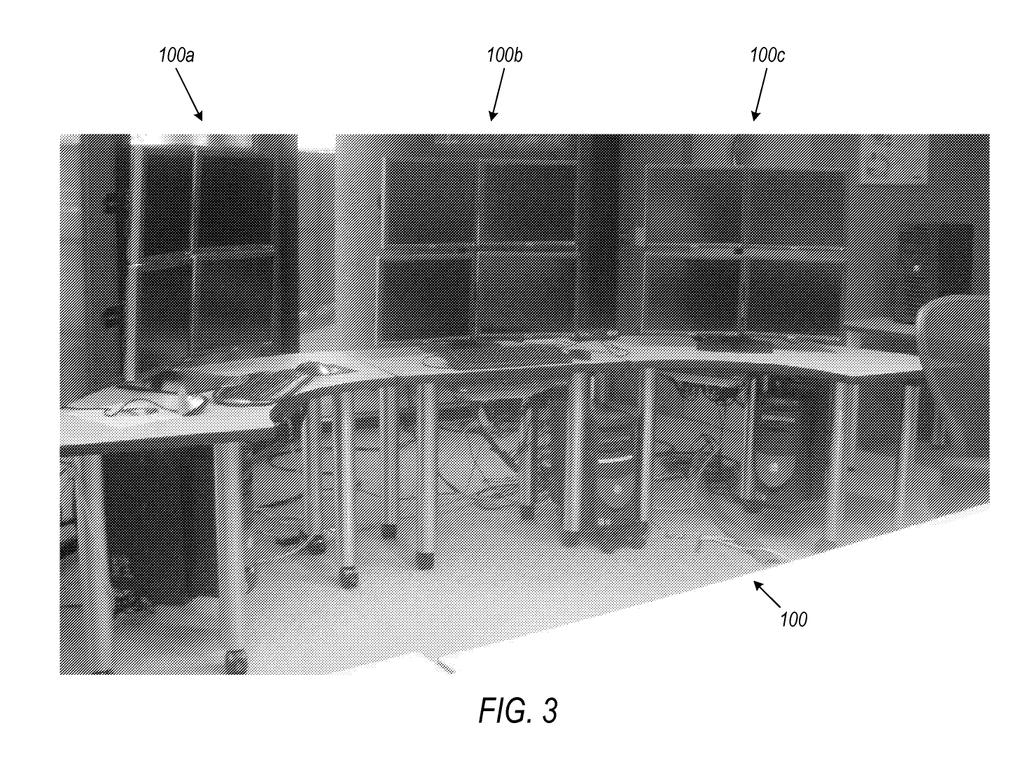

In some embodiments, the end tables 110a and 110c have their computers mounted underneath the tables, for example, in a sliding bracket. The center tables 110b, on the other hand, may have their computers residing in a wheeled basket attached to the side of the table. This arrangement can be seen in FIG. 3, where two end modules 100a and 100c and a center module 100b have been assembled to form the mobile operation support center 100. In the arrangement shown, the computers have quad-output video cards (i.e., four independent video outputs) as well as 4×2 matrix switches and 4-way splitters that allow the video output to be extended to additional output devices, such as a projector or a plasma display. The video cables from the matrix switch are preferably about 7 feet long to facilitate connection to the projectors in most environments. This setup allows the operator of the mobile operation support center 100 to select and display the video output for one or more of the monitors on additional projectors or plasma displays. As a result, the various video outputs may be provided to a wider audience and/or sent to remote locations (i.e., video conferencing) to facilitate collaborative workflows with personnel at the remote locations.

The keyboard and mouse for each module or station are preferably a wireless keyboard and mouse. When two or more modules or stations of the mobile operation support center 100 are assembled together, however, the wireless keyboard and mouse may be controlled by using a single mouse and keyboard attached to an appropriate switch that allows the operator to change keyboard and mouse control from one computer to another.

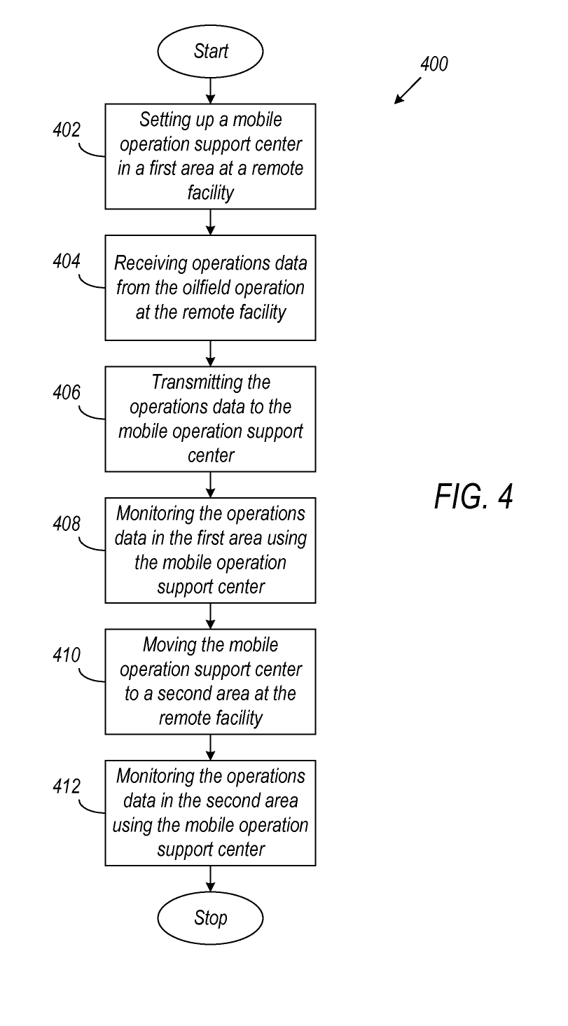

FIG. 4 illustrates a method 400 that may be used to support an oilfield operation using the modular mobile operation support center in accordance with preferred embodiments of the invention. As can be seen, the method 400 begins at step 402 by setting up a mobile operation support center in a first area (e.g., a control room) at a remote facility, either at an oilfield client's facility or an oilfield service provider's facility. At step 404, operations data from the oilfield operation, including video data, measurement data, and the like, is received at the remote facility. At step 406, the operations data is transmitted to the mobile operation support center at the remote facility. At step 408, appropriately-trained support personnel may monitor the operations data in the first area using the mobile operation support center. At step 410, the mobile operation support center is moved in a substantially assembled state to a second area (e.g., a conference room) at the remote facility. Finally, at step 412, appropriately-trained support personnel may monitor the operations data in the second area using the mobile operation support center.

Although the foregoing is provided for purposes of illustrating, explaining and describing certain embodiments of the invention in particular detail, modifications and adaptations to the described methods, systems and other embodiments will be apparent to those skilled in the art and may be made without departing from the scope or spirit of the invention.

What is claimed is:

1. A mobile operation support center for supporting an oilfield operation, comprising:
one or more tables, each table having a plurality of legs, each leg having a wheel attached thereto;
a computer mounted to each table, the computer being equipped with multiple independent video outputs;
one or more monitor displays disposed on top of each table, each monitor display being connected to one of the video outputs of the computer; and
at least one video matrix switch mounted to each table, the at least one video matrix switch being connected to the video outputs of the computer and operable to provide one or more of the video outputs of the computer to an external display device;
wherein the one or more tables and the computer mounted thereto may be moved from one room to another in a substantially assembled state for supporting the oilfield operation.

2. The mobile operation support center of claim 1, wherein each table has a size and shape that allows the table to pass through a standard-sized doorway.

3. The mobile operation support center of claim, wherein the computer is further equipped with a network communication card for establishing a wired and/or wireless connection with a network.

4. The mobile operation support center of claim 1, wherein the one or more tables comprise at least one end table and at least one center table, the end table and the center table being lockable together to form a single unit.

5. The mobile operation support center of claim 4, wherein the at least one end table has a substantially quarter-circle shape and the at least one center table has a substantially rectangle shape.

6. The mobile operation support center of claim 1, wherein the monitor displays are arrayed in a 2×2 array on top of each table.

7. The mobile operation support center of claim 1, wherein for at least one table, the computer is mounted underneath the table using a hanging bracket.

8. The mobile operation support center of claim 1, wherein for at least one table, the computer is mounted at the side of the table using a wheeled basket.

9. The mobile operation support center of claim 1, wherein the computer, monitor displays, and video matrix switch for each table may be powered from a single power source.

10. A method of providing support for an oilfield operation, comprising:
setting up a mobile operation support center in a first area at a remote facility;
receiving operations data from the oilfield operation at the remote facility;
monitoring the operations data in the first area using the mobile operation support center;
moving the mobile operation support center in a substantially assembled state to a second area at the remote facility; and
monitoring the operations data in the second area using the mobile operation support center.

11. The method according to claim 10, further comprising displaying the operations data in an area external to the first area using the mobile operation support center.

12. The method according to claim 10, further comprising scaling a capacity of the mobile operation support center according to a complexity of the oilfield operation.

13. The method according to claim 10, wherein the remote facility is one of: an oilfield service provider's facility and an oilfield client's facility.

14. A mobile operation support center for supporting an oilfield operation, comprising:
means for deploying a computer, the computer being equipped with multiple independent video outputs;
means for displaying output video from the multiple independent video outputs of the computer; and
means for providing at least one video matrix switch mounted to each table, the at least one video matrix switch connected to the video outputs of the computer and operable to provide one or more of the video outputs of the computer to an external display device;
wherein the means for deploying the computer may be moved from one room to another in a substantially assembled state for supporting the oilfield operation.

15. The mobile operation support center of claim 14, wherein the means for deploying a computer comprises at least one table, each table having a size and shape that allows the table to pass through a standard-sized doorway.

16. The mobile operation support center of claim 15, wherein the one or more tables comprise at least one end table and at least one center table, the end table and the center table being lockable together to form a single unit.

17. The mobile operation support center of claim 16, wherein the at least one end table has a substantially quarter-circle shape and the at least one center table has a substantially rectangle shape.

18. The mobile operation support center of claim 16, wherein the means for displaying output video comprises a plurality of monitor displays, the monitor displays arrayed in a 2×2 array.

19. The mobile operation support center of claim 16, wherein the means for deploying, the means for displaying, and the means for providing may be powered from a single power source.
